(19) United States
(12) Patent Application Publication
(10) Pub. No.: US 2026/0276173 A1
(43) Pub. Date: Sep. 17, 2026

(54) A LAMP FOR SUSPENDED MOUNTING

(71) Applicant: SIGNIFY HOLDING B.V., EINDHOVEN (NL)

(72) Inventor: KRZYSZTOF CEZARY ZAREMBA, BIALYSTOK (PL)

(21) Appl. No.: 19/167,886

(22) PCT Filed: Mar. 19, 2024
(86) PCT No.: PCT/EP2024/057315

§ 371 Date: Sep. 23, 2025

(30) Foreign Application Priority Data
Mar. 23, 2023 (EP) 23163736.4

(51) Int. Cl. F21V 5/00; F21S 8/06; F21V 7/00; F21V 7/22; F21V 15/01; F21V 15/015; F21Y 103/10; F21Y 115/10

(52) U.S. Cl. CPC F21V 5/002; F21S 8/061; F21V 7/0091; F21V 7/22; F21V 15/013; F21V 15/015; F21Y 2103/10; F21Y 2115/10

(57) ABSTRACT

A lamp for mounting suspended from a ceiling comprising an integrally formed housing and an elongate light source housed within the integrally formed housing, The integrally formed housing comprising two side walls that are angled with respect to a base and wherein the side walls are configured to transmit no less than 75% of light received from the base. The base comprises a plurality of microstructures on a side facing away from the interior of the housing. The microstructures are configured to reflect a portion of the light received at the interior surface of the base at an angle of more than 45 degrees with the interior surface from the elongated light source, back into the interior of the housing.

### FIELD OF THE INVENTION

The present invention relates to the field of artificial lighting, and in particular, to the field of lamps for suspended mounting.

### BACKGROUND OF THE INVENTION

The use of artificial lighting is becoming increasingly common, with luminaires becoming more popular due to their high energy efficiency and flexibility of use. Luminaires are found in a wide variety of environments, including domestic, industrial, clinical, educational and/or office environments.

One form of light source used in luminaires is an elongate light source, such as a tubular light source or a linear array of LEDs.

U.S. Pat. No. 3,159,352 discloses a luminaire and more particularly an improvement to a refractor therefore, that provides a considerable portion of the light flux upwards at about a 45 degrees angle, whereby, when the luminaires are mounted on stems beneath the room ceiling, the brightness difference between the ceiling and the luminaires is substantially reduced,

International patent application WO02/44612 A2 discloses a light with a transparent panel that extends cross wise to the direction of emissions, that aims to improve the light in terms of glare suppression. To this end the transparent panel is provided with a microstructure and light homogenization means.

There is an increasing desire for luminaires to distribute light within a limited range of angles, to reduce the impact of glare upon individuals within the vicinity of the luminaries. Luminaire optics make use of two common methods to limit light distribution at large angles: namely redirection (e.g., refraction and/or reflection) or absorption. Absorption will significantly affect the efficiency or light output ratio (LOR) of the luminaire.

There is therefore a demand for more efficient luminaire optics.

### SUMMARY OF THE INVENTION

The invention is defined by the claims.

According to examples in accordance with an aspect of the invention, there is provided a lamp for suspended mounting comprising an integrally formed housing and an elongate light source housed within the integrally formed housing. The integrally formed housing comprises: a first side wall; a second side wall; and a base connected to the first and second side walls, wherein the first side wall and the second side wall are flat side walls that extend substantially above the base and are configured to transmit no less than 75% of light received from the base and, wherein: a volume bound by the first side wall, the second side wall and the base defines an interior of the integrally formed housing. Light emitted by the elongate light source, is received at an interior surface of the base that faces the interior of the integrally formed housing and an exterior surface of the base, facing away from the interior of the integrally formed housing, comprises a plurality of microstructures that each extend away from the interior of the integrally formed housing for redirecting a portion of light received at the interior surface of the base at an angle of incidence of more than 45 degrees with the interior surface from the elongate light source, back into the interior of the integrally formed housing.

The plurality of microstructures is configured to transmit a majority, substantially all, light received at the interior surface of the base, and having an angle of incidence less than 45 degrees with respect to the interior surface, through the base of the housing. This provides a housing that transmits lights received at relatively small angles and is unlikely to cause glare to illuminate a region below the housing.

The present disclosure provides a housing that performs an optical role on or optical manipulation of light emitted by an elongate light source. In particular, a plurality of microstructures are positioned on an external surface of a base of the housing. These microstructures thereby act to reflect light emitted at relatively large angles (to an optical axis), by an elongate light source positioned within the housing, back into the housing. The reflected light then escapes the housing via the first and second flat side walls.

Through appropriate selection of characteristics of the side walls and/or housing, e.g., choice of material, thickness of the side walls, shape of the side walls, angle of the side walls and so on. A wide variety of different design options can be used to achieve such desired transmission characteristics, as would be well known to the skilled person.

Configuring the side walls in this way provides a more efficient luminaire, as light is output by the side walls, and reduces a change of light being output from the luminaire in directions that are likely to increase glare perceived by an individual, e.g., reduce a number of rays emitted at relatively high angles.

The combination of the housing and elongate light source therefore provide a highly efficient lamp and/or luminaire, in which substantially all (e.g., >90%) of generated light is emitted out from the combination of the housing and elongate light source, whilst reducing the amount of light emitted at relatively large angles with respect to an optical axis of the light source, thereby reducing glare.

The side walls and base of the housing together define a volume whose boundaries are defined by the side walls and the base. The elongate light source is housed within the integrally formed housing within this defined volume.

The integrally formed housing is monolithic, in that it is formed from an unbroken piece of material. Suitable materials for forming an integrally formed housing are well established in the art, e.g., polycarbonate, PMMA or silicone.

The base of the housing is at least partially transmissive, such that at least some of the light incident upon the base (from a light source positioned within the interior) is transmitted through the base.

In some examples, the first side wall is connected to the base by a first curved connection portion; and the second side wall is connected to the base by a second curved connection portion.

Use of curved connection portions reduces or avoids the use of angled or edge parts (e.g., corners) that would otherwise increase (uncontrolled) light loss out of the housing.

The first and second curved connection portions form part of the integrally formed housing. Thus, the integrally formed housing comprises the first and second curved connection portions.

Preferably, the radius of curvature of each of the first curved connection portion and the second curved connection portion is no less than 4 mm, e.g., no less than 5 mm. This embodiment further reduces the emission of stray or uncontrolled light out of the housing for improved performance of a luminaire comprising such a housing.

The plurality of microstructures may be configured to redirect no less than 15% of light received at the interior surface of the base towards the interior of the integrally formed housing. Such embodiments can be achieved through appropriate selection of the characteristics of the plurality of microstructures, e.g., by way of designing their shape, surface roughness and/or size. Approaches for configuring microstructures to achieve desired reflection characteristics are known in the art.

In some examples, the plurality of microstructures are configured to redirect substantially all light received at the interior surface of the base, and having an angle of incidence greater than 65° with respect to the interior surface, towards the interior of the integrally formed housing. This technique substantially reduces an amount of light emitted from a luminaire having the integrally formed housing that is likely to cause glare or discomfort to an individual illuminated by the luminaire. In particular, by reflecting light incident at high angles (e.g.,)>65°, transmission of such light through the base is avoided and glare is substantively reduced.

The plurality of microstructures may comprise two or more microstructures that are each configured to have five or more surface normals in directions away from the interior of the of the integrally formed housing, each surface normal making a non-zero angle with respect to each other surface normal.

This embodiment provides a technique for reflecting light incident upon the base at relatively high angles (e.g., light that may otherwise cause glare) whilst increasing a diffusion performed on refracted light, thereby providing a more uniform light distribution of light output through the integrally formed housing.

In some examples, the plurality of microstructures comprises two or more microstructures having a domed, conical, half-sphere or truncated-spherical shape, or facetted dome. These forms of microstructure have been identified as increasing the number of rays reflected at relatively high angles across a different range of angles (e.g., a range of angles around an optical axis of the light source).

The plurality of microstructures may comprise two or more microstructures having a pyramidal shape.

The plurality of microstructures may comprise two or more microstructures shaped as a triangular prism. Such embodiments provide microstructures that are capable of improving the glare of a luminaire whilst being simple to manufacture and/or produce directly with the integrally formed housing.

In preferred examples, the integrally formed housing is configured to absorb less than 5% of light incident thereon. This can be achieved through appropriate selection of the properties (such as the material, surface roughness and/or thickness) of the integrally formed housing. This embodiment improves the efficiency of the combination of the light source and housing when they are used together.

The integrally formed housing may be an extruded integrally formed housing. In this way, the integrally formed housing can be manufactured in a simple and easily adaptable approach, e.g., to account for different lengths of different elongate light sources.

There is also proposed a method of manufacturing an integrally formed housing, the method comprising using an extrusion process to produce an integrally formed housing as defined in the claims. The method may also make use of a stamping or embossment process (e.g., a hot embossment process) to produce the microstructures on the base. Thus, the method may comprise using an extrusion process to produce the side walls and the base, before forming the microstructures using an embossment process.

Preferably, the housing comprises one or more light source coupling elements configured to couple with the elongate light source. In particular, at least one light source coupling element may comprise a supporting structure having an aperture configured to receive the elongate light source (e.g., slide over the elongate light source) to thereby allow mechanical coupling of the light source to the integrally formed housing.

Preferably, the light source coupling element(s) is/are configured such that, when the light source is coupled to the housing, electrical and mechanical connection of the elongated light source with a suspended element (e.g., a suspended wire) is facilitated. This can be achieved through appropriately sized and/or positioned apertures in the light source coupling element(s).

In some examples, the elongate light source is a tubular LED. The tubular LED may comprise its own optics, such as a diffuser, or may be devoid of any such optics. In some examples, the elongate light source comprises a plurality of linearly positioned LEDs or LED arrays, wherein a pitch between each LED or LED array is less than 10 mm. A reduced pitch increases the uniformity of light output by the lamp.

There is also proposed a luminaire comprising any herein described lamp. The luminaire may comprise any additional mechanical supports and/or electrical components for realizing an operational light fixture or fitting.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a luminaire having a proposed integrally formed housing;

FIG. 2 provides a perspective view of the integrally formed housing;

FIG. 3 illustrates a propagation of light in the integrally formed housing;

FIG. 4 illustrates example microstructures for use in an embodiment;

FIG. 5 illustrates properties of an example integrally formed housing;

FIG. 6 illustrates a luminaire having another integrally formed housing;

FIG. 7 illustrates a cross-section of the luminaire;

FIG. 8 illustrates a mirror arrangement for a luminaire; and

FIG. 9 illustrates end caps for a luminaire.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an integrally formed housing for a luminaire. The housing comprises two side walls that are angled with respect to a base. The base comprises a plurality of microstructures on a side facing away from the interior of the housing. The microstructures are configured to reflect a portion of the light produced by a light source in the housing back into the interior of the housing.

In the field of optics, a microstructure is a known term used to refer to optical microstructures, e.g., structures on a small scale (e.g., <100 mm or <10 mm) that are able to redirect and/or reflect light incident thereon. In particular example, the size (e.g., the width, height and/or length) of an optical microstructure may be in the region of between 0.1 mm and 10 mm, e.g., between 1 mm and 2 mm.

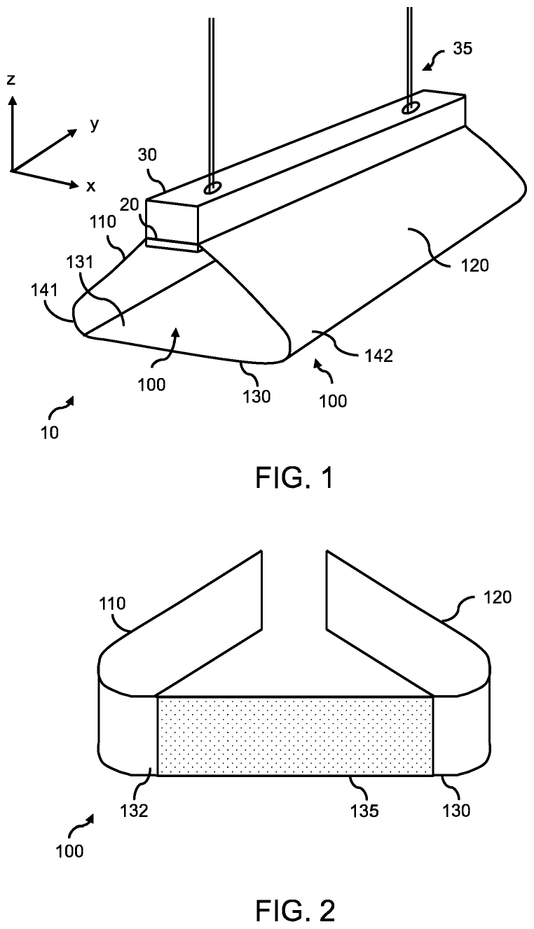

FIG. 1 illustrates a luminaire 10 or light fixture according to an embodiment. The luminaire comprises an integrally formed housing 110, an elongate light source 20 and a support member 30. The integrally formed housing 110 and the elongate light source 20 may together form a lamp according to an embodiment.

The elongate light source 20 is positioned such that light emitted by the light source 20 enters the integrally formed housing 110, particularly an interior of the housing as later defined. In preferred examples, and as illustrated, the elongate light source 20 is positioned so as to be housed or held in the integrally formed housing 110. Examples of elongate light sources are well known in the art and include a tubular LED (with or without optical elements such as a diffuser), LED strips or strings, a linear array of LEDs or other light emitting devices and/or a halogen tube.

The elongate light source 20 may extend along a predetermined axis, e.g., axis y. In particular, the direction in which the elongate light source extends may define the direction of the axis y.

The support member 30 is configured to provide structural support to the light source 20 and/or the integrally formed housing 110. The support member 30 may, for instance, carry additional circuitry (not shown) for the light source, such as driving circuitry, control circuitry, communication circuitry, filtering circuitry and so on. The support member 30 may, in use, be suspended using one or more cables and/or wires 35, e.g., from a ceiling (not shown). Such cables 35 may mechanically secure the support member 30 to the ceiling or other surface. Of course, one or more wires/cables may carry an electrical power for powering the light source 20, but these cables do not necessarily need to provide any structural support to the support member 30.

The integrally formed housing 100 is formed of a monolithic piece of material, e.g., a piece of material that is continuous. Suitable materials for the integrally formed housing include polycarbonate, PMMA or silicone. Preferably, the material and thickness of the housing is configured such that it absorbs less than 5% of light incident thereon.

The integrally formed housing 100 comprises a first side wall 110, a second side wall 120 and a base 130 connected to the first 110 and second 120 side walls. In the illustrated example, the first 110 and second 120 side walls each make a non-zero angle with respect to the base 130. As shown in FIG. 1, the first 110 and the second 120 side walls are flat side walls.

A volume 150, bound by the first side wall 110, the second side wall 120 and the base 130, defines the interior 150 of the integrally formed housing. Thus, light emitted by a light source 20 positioned in the interior of the integrally formed housing will be present in the interior 150 of the integrally formed housing. More particularly, at least some of the light emitted by such a light source 20 will be incident upon an interior surface 131 of the base 130. The interior surface 131 of the base 130 faces the interior 150.

The integrally formed housing 100 may extend in a same direction as the elongate light source 20 (when forming part of the lamp or luminaire 10). In particular, the length of the integrally formed housing, measured along axis y, is preferably no less than the length of the elongate light source, measured along axis y. This ensures that the light source can be positioned so as to emit light into the interior of the integrally formed housing.

FIG. 2 illustrates an underside of a portion of the integrally formed housing 100, for improved contextual understanding. Reference will be made to features illustrated in either of FIG. 1 or 2.

It will be understood that the base 130 is substantially planar, i.e., generally lies in a single plane, forming the interior surface 131 and an exterior surface 132 which faces away from the interior 150 of the integrally formed housing. Thus, the exterior surface 132 of the base 130 may be an opposite surface to the interior surface 131 of the base.

The exterior surface 132 comprises a plurality of microstructures 135 that each extend away from the interior 150 of the integrally formed housing 100.

The plurality of microstructures 135 are configured to redirect at least some of the light received at the interior surface 131 of the base 130 from an/the elongate light source 20 (positioned in the housing 110) back into the interior 150 of the integrally formed housing. More particularly, a substantial portion of the redirected or reflected light is redirected towards the (angled) side walls, for transmission therethrough.

A wide variety of different microstructure configurations and designs are usable for redirecting or reflecting light back into the interior 150 of the integrally formed housing. In particular, the skilled person would understand how the shape, surface roughness, distribution, size and/or array pattern of microstructures will affect how much light is reflected by a plurality of microstructures.

By way of example only, Rekštytė, S., T. Jonavičius, and M. Malinauskas. “Direct laser writing of microstructures on optically opaque and reflective surfaces.” Optics and Lasers in Engineering 53 (2014): 90-97 recognizes how feature size can affect reflective properties of microstructures.

The skilled person would therefore be readily capable of selecting appropriate parameters and/or properties of the microstructures in order to achieve any desired reflection or transmission of light incident upon the base 130 of the integrally formed housing 100.

As noted previously, a portion of the light that is reflected back into the interior 150 of the integrally formed housing 100 will become incident upon the side walls 110, 120. The side walls may be configured to transmit a majority of this incident light, e.g., substantially all of this incident light (e.g., barring any non-ideal scattering and/or absorption of the light). In this way, reflected light is transmitted out of the housing 110 in a direction away from the interior surface 131 of the base 130.

Embodiments thereby provide a housing for which light is partially transmitted through the base 130 and partially reflected to be transmitted through the side walls 110, 120, represented in this cross-section by flat planes. This provides a good distribution of light for an individual in the vicinity of the luminaire 10.

In use, e.g., when the luminaire 10 is suspended from a ceiling, the light reflected by the plurality of microstructures will thereby illuminate upwards (i.e., illuminate the ceiling). Light transmitted through the base 130 will illuminate below the luminaire, i.e., illuminate downwardly.

The housing 110 thereby acts as part/all of the optical components for the elongate light source, providing a dual purpose effect of protecting the elongate light source and performing optical modification of light emitted by the light source.

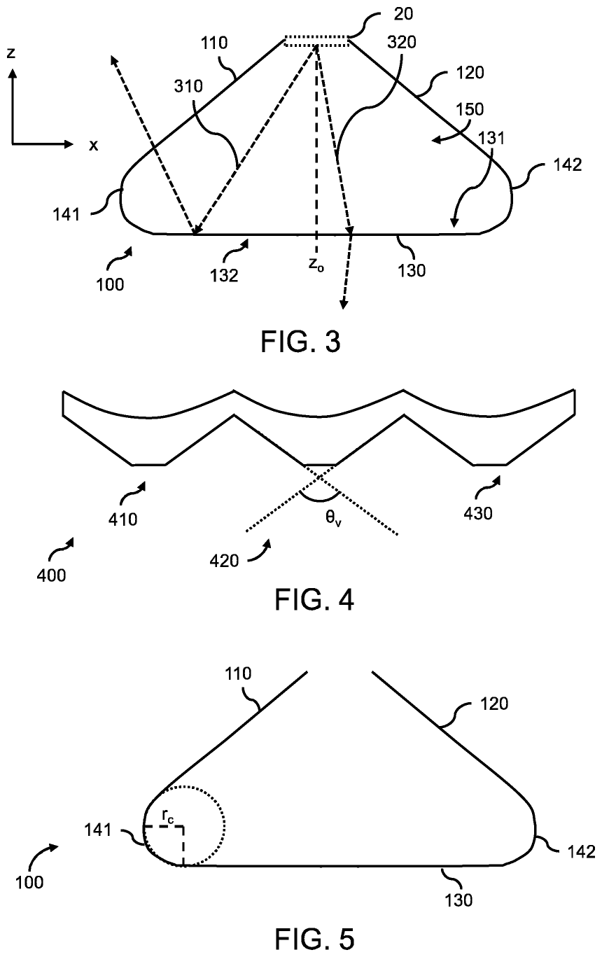

FIG. 3 conceptually illustrates the reflection of light by the plurality of microstructures according to an embodiment. More particularly, FIG. 3 provides a side view of the integrally formed housing 100. The light source 20 is also conceptually illustrated, together with its optical axis zₒ.

A first portion of light (represented by first light ray 310) received by the interior surface 131 of the base 130 (directly from the light source) is reflected by the plurality of microstructures 135 (extending outwardly from the exterior surface 132 of the base 130) back into the interior 150 of the housing 100. The first portion of light is then transmitted through the side walls 110, 120, represented in FIG. 3 as lines.

A second portion of light (represented by second light ray 320) received by the interior surface 131 of the base (directly from the light source) is transmitted through the base 130.

In the context of the present application, a surface or other part of the integrally formed housing “directly” receives a ray of light from the light source if that surface or part is the first part of the integrally formed housing to receive the ray of light from the light source. The ray of light may be transmitted or otherwise directed by one or other intermediary components (such as a diffusive foil, mirrors or the like).

Preferably, the first portion of light comprises no less than 15%, e.g., no less than 30%, of light received at the interior surface of the base towards the interior of the integrally formed housing, e.g., no less than 50% of the light received at the interior surface. Thus, the plurality of microstructures may be configured to redirect no less than 15%, e.g., no less than 30% (e.g., no less than 50%) of light received at the interior surface of the base towards the interior of the integrally formed housing.

Preferably, the second portion of light comprises no less than 15%, e.g., no less than 30%, of light received at the interior surface of the base towards the interior of the integrally formed housing, e.g., no less than 50% of the light received at the interior surface. Thus, the plurality of microstructures may be configured to transmit no less than 15%, e.g., no less than 30% (e.g., no less than 50%) of light, received at the interior surface of the base through the base.

In preferred examples, the plurality of microstructures are configured such that the first portion of light comprises substantially all light (rays) having an angle of incidence with the interior surface 131 greater than a first predetermined angle. In the context of the present disclosure, the angle of incidence is the angle that a light ray makes with respect to the optical axis zₒ. It is recognized that rays that are output from a luminaire at high angles to the vertical can cause glare to an individual in the vicinity of the luminaire. By reflecting such light back into the interior of the housing 100, glare is advantageously reduced. By configuring the side walls to transmit the reflected light, glare can be reduced without significantly affecting the efficiency of the luminaire (measured in terms of total light output per unit of energy or power drawn by the luminaire).

Thus, the plurality of microstructures may be configured to redirect substantially all light directly received at the interior surface of the base, from the light source, at an angle of incidence greater than a first predetermined angle towards the interior of the integrally formed housing.

In this way, the microstructures (positioned on the side opposite to the light source) can act to limit light distribution of the luminaire by reflecting wide rays back into the interior of the housing.

The first predetermined angle may be determined based on a desired glare rating for a luminaire comprising the housing. For instance, it has been identified that substantial amounts of light at angles higher than 65° or 60° can negatively affect glare ratings. A suitable value for the first predetermined angle is therefore 65° or 60°. However, it will be appreciated that for other use-case scenarios, e.g., where light spread is more important than glare rating or where there is a desire to further reduce glare, other values may be used.

For instance, the first predetermined angle may be a value between 45° and 70° (inclusive), e.g., between 45° and 65° (inclusive) or between 50° and 65° (inclusive). Example values for the first predetermined angle include: 45°, 50°, 55°, 60°, 65° or 70°. The skilled person would be readily capable of selecting other suitable angles and suitably configuring the base and/or the microstructures to reflect light received at such angles.

The angle of incidence may be measured or determined in a plane that lies perpendicular to a length of the elongate light source and/or housing, e.g., as illustrated in FIG. 3.

Similarly, in some examples, the plurality of microstructures are configured such that the second portion of light comprises substantially all light (rays) having an angle of incidence with the interior surface 131 less than a second predetermined angle. Thus, the plurality of microstructures may be configured to transmit substantially all light directly received at the interior surface of the base, from the light source, at an angle of incidence less than a second predetermined angle. The second predetermined angle may be identical to the first predetermined angle.

Of course, in the context of the present disclosure, the term “substantially all light” or “substantially all light rays” refers to all light rays that are not lost or redirected due to non-ideal effects such as scattering or absorption.

Preferably, the first side wall 110 and the second side wall 120 are configured to transmit no less than 75% of light received from the base, e.g., no less than 80% or no less than 85%. In particular, the side walls may be configured to transmit substantially all light incident thereon.

These embodiments can be achieved through appropriate selection of one or more properties of the side walls, e.g., to select appropriate angles and/or surface roughness to reduce undesirable reflection or scattering, and/or selection of the material of the integrally formed housing to reduce absorption. The skilled person would be readily capable of selecting or identifying a suitable material and/or structural properties to achieve this goal, such that it would be unduly limiting to restrict the scope of this feature to any specific embodiment.

FIG. 4 illustrates a cross-section of a portion of a plurality of microstructures 400 for use in an embodiment. This embodiment illustrates one example of how the structure of a microstructure can be controlled or defined in order to control an amount of reflection performed by the microstructure.

In this example, each microstructure is substantially conical in shape. More particularly, each microstructure 410, 420, 430 is formed as a truncated cone. The vertex angle θᵥ is selected or modifiable for reflection of light. Changing the value of the vertex angle will change which angles of incident light are reflected by the microstructure back into the interior of the housing. This provides one example approach or mechanism for tuning the shape of the microstructures to control or affect reflection of light by the microstructures.

In particular, lower vertex angles will increase the reflectivity of the microstructure, as more rays will become incident upon the surface/boundary of the microstructure at larger angles, and thereby undergo total internal reflection.

As a working example, the value of the vertex angle θᵥ is a value between 100° and 120°, e.g., 108° or 110°.

As illustrated, the microstructure may comprise a dimple or indent at the vertex of the truncated cone. This has been identified as providing improved reflective performance and reduces a risk of unusual or expected redirections of light.

Similarly, the microstructure may comprise a dimple or indent at the base of the cone, opposite the truncated cone vertex. This approach has also been identified as providing improved reflective performance and reduces a risk of unusual or expected redirections of light.

Other suitable forms of microstructures are hereafter described. Embodiments may make use of only one of the herein described forms of microstructure or a combination of two or more forms of the microstructure.

In some examples, a microstructure may be configured to have five or more surface normals in directions away from the interior of the of the integrally formed housing, each surface normal making a non-zero angle with respect to each other surface normal. This improves the reflective performance of the microstructure with respect to 360° coverage of light emitted by the light source.

A microstructure may have a domed, conical, half-sphere or truncated-spherical shape, or facetted dome. These forms of microstructures are shown to have good reflective properties for a wide range of angles of incidence of light rays.

A microstructure may have a pyramidal shape. Such structures are easy to form or impress within an integrally formed piece of material, for improved ease of manufacturing the integrally formed luminaire without significantly affecting efficiency.

A microstructure may be shaped as a triangular prism. Such microstructures can be readily created using a roller within an integrally formed piece of material, facilitating increased ease and flexibility in manufacturing the housing, e.g. without the need for pressing or embossing.

Turning back to FIGS. 1 and 3, preferably the first side wall 110 is connected to the base 130 by a first curved connection portion 141 and the second side wall 120 is connected to the base 130 by a second curved connection portion 142.

Thus, the integrally formed housing 100 may further comprise a first curved connection portion 141 that connects the first side wall 110 to the base 130 and a second curved connection portion 142 that connects the second side wall 120 to the base 130. The curved connection portions thereby effectively provide a smooth transition from the side wall(s) to the base.

The use of curved connection portions in this way reduces any loss of light, e.g., light lost due to unpredictable or uncontrollable interactions with edges between two walls or sides of a housing. A curved connection portion will facilitate control over this light, to improve the light distribution properties of a luminaire comprising such an integrally formed housing.

FIG. 5 illustrates another view of a cross-section of the housing 100 to explain a preferred embodiment for the curved connection portion, connecting the base 130 to the first side wall 110 and the second side wall 120, here shown as lines.

In particular, a curved connection portion 141, 142 will have a radius of curvature, e.g., as measured in a plane lying perpendicular to the direction in which the elongate light source extends.

In preferred examples, the radius of curvature r_{c} of each of the first curved connection portion and the second curved connection portion is no less than 4 mm, e.g., no less than 5 mm. Such a radius of curvature has been identified as reducing the amount of stray light (i.e., uncontrolled light) emitted from a luminaire having such a housing, thereby improving the performance of the luminaire.

In the example previously illustrated, particularly with reference to FIG. 1, the integrally formed housing 100 is configured to couple to the support member 30 so as to be mechanically supported by the support member 30.

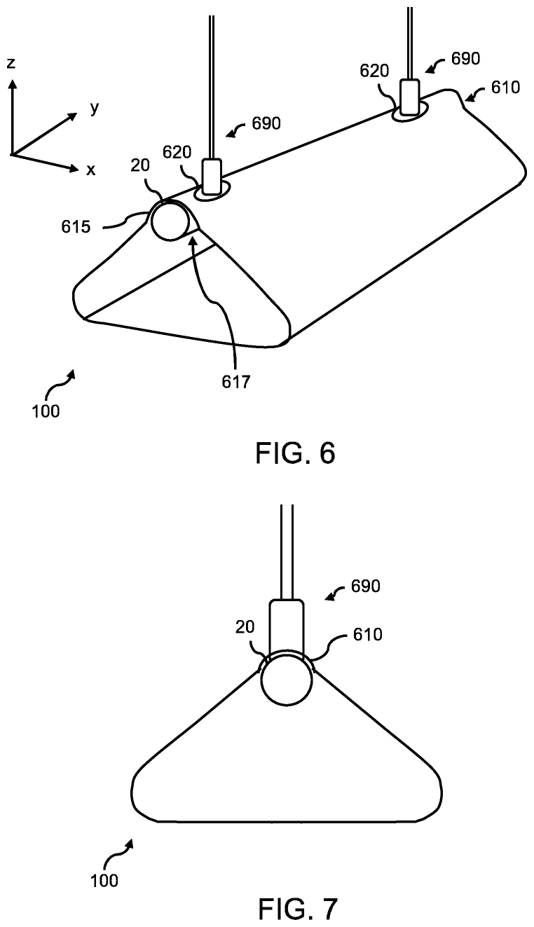

FIGS. 6 and 7 illustrate an alternative approach in which the integrally formed housing 100 comprises a light source coupling element 610 configured to couple the integrally formed housing to the elongate light source 20.

In particular, the light source coupling element 610 comprises a supporting structure 615 having an aperture 617 or receiving element configured to receive the elongate light source 20 (e.g., slide over the elongate light source) to thereby allow mechanical coupling of the light source 20 to the integrally formed housing 100. The aperture may, for instance, extend in the direction of the elongate light source 20, such that the elongate light source is able to be supported or coupled along the length of the elongate light source for improved security.

The light source coupling element(s) may be configured such that, when the light source is coupled to the housing, electrical and mechanical connection of the elongated light source with a suspended element 690 (e.g., a suspended wire) is facilitated. This may be in the form of one or more through holes or cutouts 620 in the light source coupling element 610 to allow for connection of a suspended element 690 to the light source 20.

The light source coupling element 610 may further comprise additional coupling elements (not illustrated) for securing to the light source, e.g., one or more clips or straps.

In this illustrated example, the light source 20 is a tubular LED. Thus, the light source coupling element 610 is appropriately shaped to receive or couple to the tubular LED. The skilled person will appreciate that the light source coupling element 610 may be appropriately shaped and/or configured for other forms of light source.

Preferably, any above described integrally formed housing is formed using an extrusion process. This provides repeatable and reliable production of a housing that can be easily adapted to any length of an elongate light source. It has been recognized that the herein proposed housing can be advantageously formed using an extrusion process for increased efficiency and speed of manufacture.

Thus, there is proposed a method of manufacturing an integrally formed housing comprising producing an integrally formed housing comprises the side walls and the base using an extrusion process. The microstructures, these may also be formed as part of the extrusion process (e.g., if the microstructures are triangular prisms) or by extruding the housing over a roller, which applies the microstructures as the housing is extruded.

Alternatively, the microstructures may be formed using a subsequent stamping or embossment (e.g., hot embossment) process to an extruded housing, to form an integrally formed housing with the microstructures.

It is known for an elongate light source to comprise a plurality of linearly positioned LEDs or LED arrays, e.g., linearly arranged LED modules.

For use in the present invention, if such elongate light sources are used, it is preferable if the pitch (e.g., center-to-center distance) between such LED modules to be less than 10 mm. When used in a luminaire with the proposed integrally formed housing, a more uniform output of light from the luminaire is achieved with pitch values less than 10 mm, e.g. less than 8 mm,

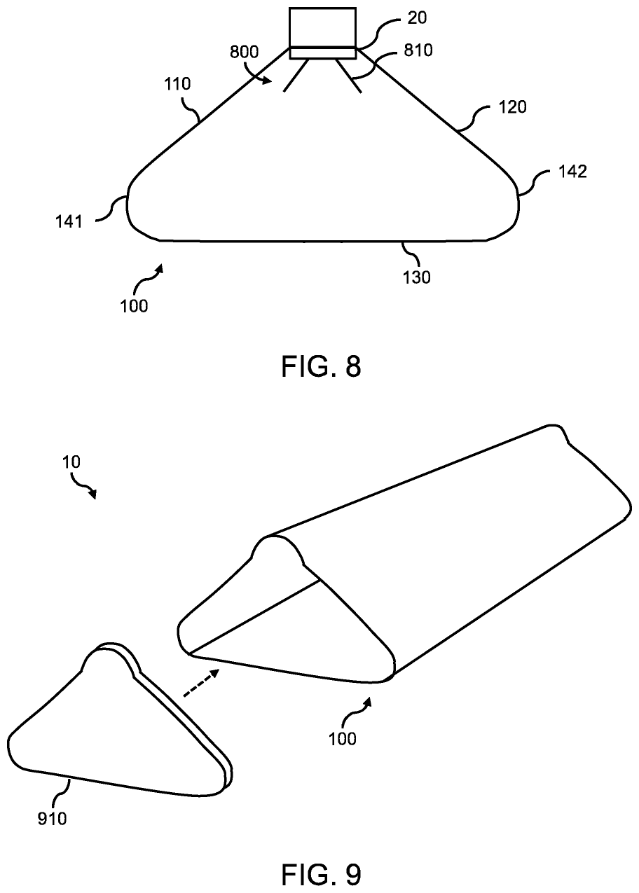

FIG. 8 illustrates a lamp or luminaire 10 having an additional optional feature according to an embodiment.

The additional optional feature is a reflective arrangement 800. The reflective arrangement 800 comprises one or more mirrors 810 coupled at or near the elongate light source 20 and configured to collimate, direct or funnel light output by the elongate light source towards the base 130. In particular, each mirror 810 may make a non-zero angle with respect to the base 130, such that light incident upon the mirror 810 from the light source is redirected towards the base.

The reflective arrangement 800 is therefore configured to redirect a side part of light output by the elongate light source (e.g., light output at high angles) towards the base. More particularly, the reflective arrangement may be positioned and/or configured to redirect light that would otherwise not be incident upon the base 130 (and more preferably, the plurality of microstructures formed in the base) to become incident upon the base 130 (and more preferably, the plurality of microstructures formed in the base). This can be achieved though appropriate selection of the position and angle of the reflective arrangement.

Use of the reflective arrangement in this way improves the performance of the luminaire, e.g., by reducing stray light and/or uncontrolled light. The reflective arrangement also acts to further reduce any direct glare, e.g., to reduce an amount of light that is directly output through the side wall(s) 110, 120 and/or curved connection portions 141, 142 (if present) from the light source 20.

It will be clear that the reflective arrangement 800 can be used with any herein described luminaire and/or integrally formed housing, such as those illustrated by FIGS. 6 and 7.

FIG. 9 illustrates another optional feature for a luminaire 10. Some elements of the luminaire, such as the elongate light source, are not shown for illustrative clarity.

In particular, a luminaire may further comprise one or more end caps 910 configured to cover or enclose an exposed end of integrally formed housing. Each end cap 910 may be configured to engage or be otherwise mechanically secured to the integrally formed housing.

The end cap 910 may, when coupled to the integrally formed housing, lie perpendicularly to the side walls and/or base of the integrally formed housing. Thus, the end cap 910 may lie perpendicularly to a direction in which an elongate light source housed by the housing lies.

Use of an end cap improves the ingress protection of the luminaire.

The end cap is preferably formed of the same material as the integrally formed housing, for improved consistency and uniformity.

There is also proposed a lamp comprising any herein described integrally formed housing and an elongate light source housed within the integrally formed housing. There is also proposed a luminaire comprising such a lamp, e.g., together with any additional fixtures, fitting and/or other lamps for forming a luminaire or light fixture.

In some embodiments, a luminaire comprising a proposed integrally formed housing further comprises a diffusive foil, e.g., positioned on the inner surface of the base. A diffusive foil is a sheet or generally planar structure configured to diffusively transmit light received thereon. Use of a diffusive foil will increase the uniformity of light output by the luminaire. However, a diffusive foil will absorb light (typically, 6%-7% of received light), such that omission of the diffusive foil may be preferred for improved efficiency.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A luminaire for suspended mounting comprising
a housing; and
an elongate light source housed within the housing, the housing comprising:
a first side wall;
a second side wall; and
a base connected to the first and second side walls, wherein the first side wall and the second side wall extend substantially above the base and, wherein:
a volume bound by the first side wall, the second side wall and the base defines an interior of the housing;
light emitted by the elongate light source, is received at an interior surface of the base that faces the interior of the housing; and
an exterior surface of the base, facing away from the interior of the housing, comprises a plurality of microstructures that each extend away from the interior of the housing for redirecting a portion of light received at the interior surface of the base from the elongate light source, back into the interior of the housing, wherein the plurality of microstructures are structures on a small scale that are able to redirect and/or reflect light incident thereon and where a microstructure is smaller than 100 mm;
the luminaire characterized in that: the housing is an integrally formed housing; the first side wall and the second side wall are flat and are configured to transmit no less than 75% of light received from the base; the portion of light is that portion of light at an angle of incidence of more than 45 degrees with the interior surface of the base; the housing further comprising a light source coupling element, extending above the base, the light source coupling element connected to the first side wall and the second side wall, the light source coupling element configure to couple the integrally formed housing to the elongate light source, wherein the light source coupling element comprises a supporting structure having an aperture to receive the elongate light source to thereby allow mechanical coupling of the light source to the integrally formed housing.

2. The luminaire of claim 1, wherein the first side wall is connected to the base by a first curved connection portion; and the second side wall is connected to the base by a second curved connection portion.

3. The luminaire ap of claim 2, wherein the radius of curvature of each of the first curved connection portion and the second curved connection portion is no less than 4 mm.

4. The luminaire of claim 1, wherein the plurality of microstructures are configured to redirect no less than 15% of light received at the interior surface of the base towards the interior of the integrally formed housing.

5. The luminaire any of claim 1, wherein the plurality of microstructures are configured to redirect substantially all light received at the interior surface of the base and having an angle of incidence greater than 65° with respect to the interior surface, towards the interior of the integrally formed housing.

6. The luminaire of claim 1, wherein the plurality of microstructures comprises two or more microstructures that are each configured to have five or more surface normals in directions away from the interior of the of the integrally formed housing, each surface normal making a non-zero angle with respect to each other surface normal.

7. The luminaire of claim 1, wherein the plurality of microstructures comprises two or more microstructures having a domed, conical, half-sphere or truncated-spherical shape, pyramidal or facetted dome.

8. The luminaire lamp of claim 1, wherein the plurality of microstructures comprises two or more microstructures shaped as a triangular prism.

9. The luminaire of claim 1, wherein the integrally formed housing; is configured to absorb less than 5% of light incident thereon.

10. The luminaire lamp of claim 1, wherein the integrally formed housing is an extruded integrally formed housing.

11. The luminaire of claim 1, wherein the elongate light source is a tubular LED.

12. The luminaire of claim 1, wherein the elongate light source comprises a plurality of linearly positioned LEDs or LED arrays, wherein a pitch between each LED or LED array is less than 10 mm.

13. (canceled)

14. (canceled)

15. The luminaire of claim 1, wherein the aperture extends in the direction of the elongate light source, such that the elongate light source is able to be supported or coupled along the length of the elongate light source.

16. The luminaire of claim 1, wherein at least one of the width, height, and length of a microstructure of the plurality of microstructures is in the region of between 0.1 mm and 10 mm.
